(19) United States
(12) Patent Application Publication
(10) Pub. No.: US 2023/0267311 A1
(43) Pub. Date: Aug. 24, 2023

(54) Method Of Selection And Optimization Of Auto-Encoder Model

(71) Applicant: MakinaRocks Co., Ltd., Seoul (KR)

(72) Inventors: Jongsun SHINN, Seoul (KR); Yongsub LIM, Chungcheongnam-do (KR); Songsub LEE, Seoul (KR)

(73) Assignee: MakinaRocks Co., Ltd., Seoul (KR)

(21) Appl. No.: 18/104,707

(22) Filed: Feb. 1, 2023

(30) Foreign Application Priority Data
Feb. 22, 2022 (KR) 10-2022-0022768
Dec. 15, 2022 (KR) 10-2022-0175436

(51) Int. Cl. G06N 3/0455

(52) U.S. Cl. CPC G06N 3/0455

(57) ABSTRACT

Disclosed is a method for performing an operation related to an auto-encoder model, which is performed by a computing device including at least one processor, which has optimizing an auto-encoder model as a problem to be solved. Specifically, disclosed is a method including: measuring a reconstruction error (RE) value for noise with respect to at least one of a trained auto-encoder model or an auto-encoder model being trained based on a data set; and performing at least one operation of an operation of changing a size of the trained auto-encoder model or an operation of stopping training of the auto-encoder model being trained, based on the reconstruction error value for the noise.

### CROSS-REFERENCE TO RELATED APPLICATIONS

This application claims priority to and the benefit of Korean Patent Application No. 10-2022-0022768 filed in the Korean Intellectual Property Office on Feb. 22, 2022, the entire contents of which are incorporated herein by reference.

### TECHNICAL FIELD

The present disclosure relates to a method of selection and optimization of an auto-encoder model, and more particularly, to a method of selecting a parameter of a trained auto-encoder model or an auto-encoder model being trained, and optimizing a model.

### BACKGROUND ART

An auto-encoder may encode input data into a latent space of a smaller dimension than original input data, and then decode the input data again to output reconstruction data. In this case, the reconstructed data and the input data are compared to output a reconstruction error value, and in the reconstruction error value, the input data and the reconstruction data are regarded as points in an n-dimension coordinate space, and a distance between two points is used as an index of an input/output difference. Since the auto-encoder used for anomaly detection which is one of use examples of the auto-encoder is trained to well reconstruct only normal data, when abnormal data is input, encoding and decoding are not effectively performed. Therefore, the abnormal data has a property of having a large reconstruction error value, and as the property is maximized, performance may be high. In this case, it is known that the property is influenced by a training epoch or a size of a network inside the auto-encoder. However, a problem in that when the training epoch or the network size increase by a predetermined level, there is no difference between the input data and the reconstruction data and the reconstruction error value may not be output, i.e., a problem in that the auto-encoder substantially trains an identity function occurs. Therefore, in order to improve the maximum sensitivity of an auto-encoder model, an optimization method which allows the auto-encoder model to have an appropriate training epoch and an appropriate network size and a method of determining and selecting an optimized model among a plurality of auto-encoder models are required.

Korean Patent Unexamined Publication No. 2021-0076438 (Jun. 24, 2021) discloses a method for detecting an ultra-high sensitive target signal based on noise analysis using deep training based on anomaly detection.

### SUMMARY OF THE INVENTION

The present disclosure has been made in an effort to optimize an auto-encoder model.

The objects of the present disclosure are not limited to the above-mentioned objects, and other objects and advantages of the present disclosure that are not mentioned can be understood by the following description, and will be more clearly understood by exemplary embodiments of the present disclosure. Further, it will be readily appreciated that the objects and advantages of the present disclosure can be realized by means and combinations shown in the claims.

An exemplary embodiment of the present disclosure provides a method for performing an operation related to an auto-encoder model, which is performed by a computing device including at least one processor. The method may include: measuring a reconstruction error (RE) value for noise with respect to at least one of a trained auto-encoder model or an auto-encoder model being trained based on a data set; and performing at least one operation of an operation of changing a size of the trained auto-encoder model or an operation of stopping training of the auto-encoder model being trained, based on the reconstruction error value for the noise.

In an alternative exemplary embodiment, the performing may include comparing the reconstruction error value for the noise and a threshold, and performing at least one operation of an operation of reducing a size of the trained auto-encoder model or an operation of stopping training of the auto-encoder model being trained when the reconstruction error value for the noise is smaller than the threshold.

In an alternative exemplary embodiment, the operation of changing the size of the trained auto-encoder model may include an operation of changing at least one of a layer size, a bottle neck size, or a complexity size of the trained auto-encoder model.

In an alternative exemplary embodiment, the method may further include: determining the size of the encoder model so that a difference between the reconstruction error value for the noise and the reconstruction error value for the data set becomes the maximum; and determining the determined size of the encoder model as an optimized size of the auto-encoder model of which the training is completed.

In an alternative exemplary embodiment, the reconstruction error value for the noise may correspond to a noise loss value indicating a difference between input random noise and reconstructed noise.

In an alternative exemplary embodiment, the method may further include: analyzing a slope of a change of the noise loss value for a change of a size of the trained auto-encoder model; identifying the size of the auto-encoder model which allows the slope to become the maximum or the minimum; and utilizing the identified size information of the auto-encoder model in order to determine the optimal size of the auto-encoder model.

In an alternative exemplary embodiment, the method may further include: determining a training epoch which allows the difference between the reconstruction error value for the noise and the reconstruction error value for the data set becomes the maximum; and stopping the training of the auto-encoder model after conducting the determined training epoch.

In an alternative exemplary embodiment, the method may further include: analyzing the slope of the change of the noise loss value for the change of the training epoch; identifying a training epoch which allows the slope to be the maximum or the minimum; and utilizing the identified training epoch information in order to determine the optimal training epoch.

Another exemplary embodiment of the present disclosure provides computer program stored in a computer-readable storage medium. When the computer program is executed by one or more processors, the computer program may include codes which allow the one or more processors to perform an operation related to an auto-encoder model. Further, the codes may include: a code for measuring a reconstruction error (RE) value for noise with respect to at least one of a trained auto-encoder model or an auto-encoder model being trained based on a data set; and a code for performing at least one operation of an operation of changing a size of the trained auto-encoder model or an operation of stopping training of the auto-encoder model being trained, based on the reconstruction error value for the noise.

Still another exemplary embodiment of the present disclosure provides a device. The device may include: a processor including one or more cores; and a memory. Further, the processor may be configured to include measuring a reconstruction error (RE) value for noise with respect to at least one of a trained auto-encoder model or an auto-encoder model being trained based on a data set, and perform at least one operation of an operation of changing a size of the trained auto-encoder model or an operation of stopping training of the auto-encoder model being trained, based on the reconstruction error value for the noise.

According to an exemplary embodiment of the present disclosure, a trained auto-encoder model or an auto-encoder model being trained can be optimized.

### BRIEF DESCRIPTION OF THE DRAWINGS

FIG. 1 is a block diagram of a computing device of selection and optimization of an auto-encoder model according to an exemplary embodiment of the present disclosure.

FIG. 2 is a schematic view illustrating a method of generating a reconstruction error value by a general auto-encoder model prior to describing an exemplary embodiment of the present disclosure.

FIG. 3 is a schematic diagram illustrating a network function according to an exemplary embodiment of the present disclosure.

FIG. 4 is a schematic view illustrating a method of performing selection and optimization of a model by using a trained auto-encoder model by a processor according to an exemplary embodiment of the present disclosure.

FIG. 5 is a graph for describing a method of calculating an appropriate model size when a processor uses a trained auto-encoder model according to an exemplary embodiment of the present disclosure.

FIG. 6 is a schematic view illustrating a method of performing model optimization by using an auto-encoder model being trained by the processor according to an exemplary embodiment of the present disclosure.

FIG. 7 is a graph for describing a method of calculating an appropriate model training epoch by using an auto-encoder model being trained by the processor according to an exemplary embodiment of the present disclosure.

FIG. 8 is a graph for describing a method of calculating an appropriate model training epoch or a model size by using an auto-encoder model processor of which training is completed or an auto-encoder model being trained by the processor according to an exemplary embodiment of the present disclosure.

FIG. 9 is a flowchart illustrating a method of performing selection and optimization of a model by using a trained auto-encoder model by a processor according to an exemplary embodiment of the present disclosure.

FIG. 10 is a flowchart illustrating a method of performing model optimization by using an auto-encoder model being trained by the processor according to an exemplary embodiment of the present disclosure.

FIG. 11 is a normal and schematic view of an exemplary computing environment in which the exemplary embodiments of the present disclosure may be implemented.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing procedure executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims. The term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, configurations, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein. In the present disclosure, a network function and an artificial neural network and a neural network may be interchangeably used.

Concepts of terms for describing exemplary embodiments of the present disclosure will be described.

In the present disclosure, ‘optimization’ of an auto-encoder model means a state in which an auto-encoder model being trained or trained may most distinguish normal data and abnormal data based on a data set. For example, ‘optimization’ of the auto-encoder model means a state in which the auto-encoder model being trained or trained implements a relatively low reconstruction error value for the normal data based on the data set, implements a relatively high reconstruction error value for the abnormal data such as noise, and can make a difference between the reconstruction error value for the normal data and the reconstruction error value for the noise be maximized. Further, ‘optimization’ of the auto-encoder model may also mean a state in which the size or the training epoch of the auto-encoder model is appropriately adjusted, and the auto-encoder well distinguishes the normal data and the abnormal data without substantially training an identity function.

In the present disclosure, the data set may mean a set of multiple data corresponding to a purpose of the auto-encoder model. Further, in the present disclosure, “trained auto-encoder model” may mean an auto-encoder model in which training is completed as large as a predetermined training epoch of one time or more based on the data set corresponding to the purpose and training stops.

In the present disclosure, “auto-encoder model being trained” as a concept compared with the trained auto-encoder model may be appreciated as an auto-encoder model of which training is scheduled to be continued in the future because a training epoch targeted by the user is not reached based on the data set corresponding to the purpose. Alternatively, a target training epoch is additionally granted to a model of which training is completed, may be appreciated as an auto-encoder model which does not reach the target training epoch.

In the present disclosure, the noise may be appreciated as data which does not correspond to the purpose of the auto-encoder model. That is, the noise may be appreciated as data which is not included in the data set.

In the present disclosure, the reconstruction error value may be appreciated as a numerical value of a difference between data input into the auto-encoder model and data output from the auto-encoder model. For example, the reconstruction error value may be appreciated as regarding the input data and the reconstruction data as points in an n-dimension coordinate space, and using a distance between two points as an index of an input/output difference. However, the method of calculating the reconstruction error value is not limited thereto.

In the present disclosure, a threshold may mean a maximized reconstruction error value when the auto-encoder model is optimized. Further, in the present disclosure, a noise loss value may mean a reconstruction error value of output noise when the noise is input into the auto-encoder model.

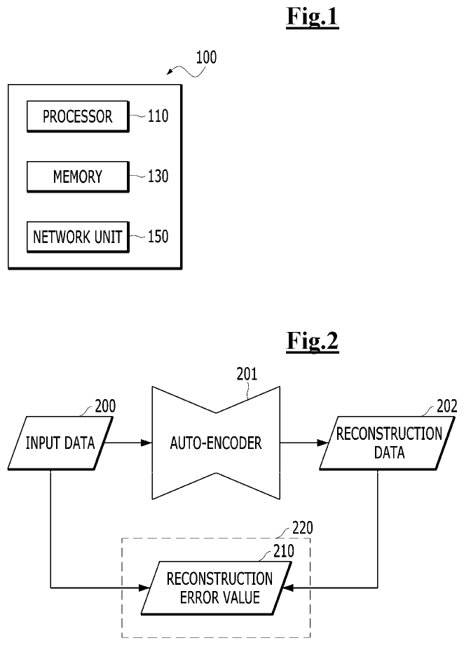

FIG. 1 is a block diagram of a computing device of selection and optimization of an auto-encoder model according to an exemplary embodiment of the present disclosure. A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100. The computing device 100 may include a processor 110, a memory 130, and a network unit 150.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data processing for machine learning according to an exemplary embodiment of the present disclosure. According to an exemplary embodiment of the present disclosure, the processor 110 may perform a calculation for training the neural network. The processor 110 may perform calculations for training the neural network, which include processing of input data for training in deep learning (DL), extracting a feature in the input data, calculating an error, updating a weight of the neural network using backpropagation, and the like. At least one of the CPU, GPGPU, and TPU of the processor 110 may process training of a network function. For example, both the CPU and the GPGPU may process the training of the network function and data classification using the network function. Further, in an exemplary embodiment of the present disclosure, processors of a plurality of computing devices may be used together to process the training of the network function and the data classification using the network function. Further, the computer program executed in the computing device according to an exemplary embodiment of the present disclosure may be a CPU, GPGPU, or TPU executable program.

According to an exemplary embodiment of the present disclosure, the memory 130 may store any type of information generated or determined by the processor 110 and any type of information received by the network unit 150.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto. The network unit 150 according to an exemplary embodiment of the present disclosure may use an arbitrary type known wired/wireless communication systems.

In the present disclosure, the network unit 110 may be configured regardless of a communication aspect, such as wired communication and wireless communication, and may be configured by various communication networks, such as a Personal Area Network (PAN) and a Wide Area Network (WAN). Further, the network may be a publicly known World Wide Web (WWW), and may also use a wireless transmission technology used in short range communication, such as Infrared Data Association (IrDA) or Bluetooth.

FIG. 2 is a schematic view illustrating a method of generating a reconstruction error value by a general auto-encoder model prior to describing an exemplary embodiment of the present disclosure.

A model structure expressed in FIG. 2 is one of the examples for describing a generally expressed reconstruction error value, and it may be appreciated by those skilled in the art that the auto-encoder structure and the method for outputting the reconstruction error value are not limited thereto.

Referring to FIG. 2, input data 200, an auto-encoder model 201, reconstruction data 202, and a reconstruction error value 210 are expressed. In this case, an operation process 220 for deriving a difference between the input data 200 and the reconstruction data 202 is also expressed. Referring to FIG. 2, the auto-encoder model 201 may generate a feature value through dimension reduction.

In the process of extracting the feature value, a non-linear relationship of each dimension of the input data 200 may also be considered. Further, in the process in which the auto-encoder model 201 compresses data into a smaller-dimension space than original input data 200, and reconstructs the data into original data to output reconstruction data 202, a feature of training data may be extracted and shown in a latent space. In this case, an expression of data in the latent space may be referred to as a latent variable, and the auto-encoder model 201 may be trained through a process of minimizing a data difference between the input data 200 and the reconstruction data 202. In this case, the data difference between the input data 200 and the reconstruction data 202 may be the reconstruction error value 210. That is, it may be known by those skilled in the art that the reconstruction error value is influenced by a data set for training and the type of input data.

It may be known that the reconstruction error value is influenced by the training epoch, and influenced by forms (e.g., a size, a complexity, etc.) of an encoder performing compression and a decoder performing reconstruction.

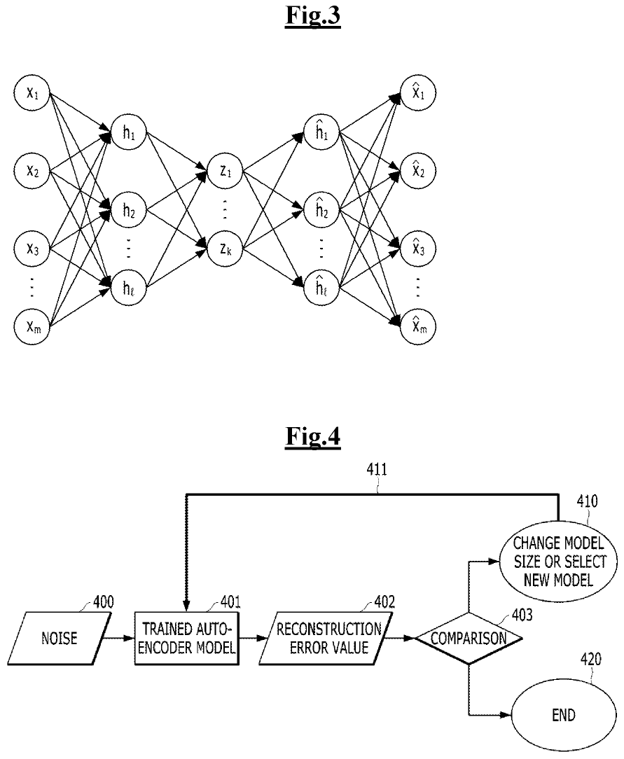

FIG. 3 is a conceptual view illustrating a neural network according to an exemplary embodiment of the present disclosure.

A neural network model according to the exemplary embodiment of the present disclosure may include a neural network for evaluating placement of the semiconductor device. Throughout the present specification, a computation model, the neural network, a network function, and the neural network may be used as the same meaning. The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links. In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, a definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

A deep neural network (DNN) may refer to a neural network that includes a plurality of hidden layers in addition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

In an exemplary embodiment of the present disclosure, the network function may include the auto encoder. The auto encoder may be a kind of artificial neural network for outputting output data similar to input data. The auto encoder may include at least one hidden layer and odd hidden layers may be disposed between the input and output layers. The number of nodes in each layer may be reduced from the number of nodes in the input layer to an intermediate layer called a bottleneck layer (encoding), and then expanded symmetrical to reduction to the output layer (symmetrical to the input layer) in the bottleneck layer. The auto encoder may perform non-linear dimensional reduction. The number of input and output layers may correspond to a dimension after preprocessing the input data. The auto encoder structure may have a structure in which the number of nodes in the hidden layer included in the encoder decreases as a distance from the input layer increases. When the number of nodes in the bottleneck layer (a layer having a smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be trained in at least one scheme of supervised learning, unsupervised learning, semi supervised learning, or reinforcement learning. The learning of the neural network may be a process in which the neural network applies knowledge for performing a specific operation to the neural network.

The neural network may be trained in a direction to minimize errors of an output. The training of the neural network is a process of repeatedly inputting training data into the neural network and calculating the output of the neural network for the training data and the error of a target and back-propagating the errors of the neural network from the output layer of the neural network toward the input layer in a direction to reduce the errors to update the weight of each node of the neural network. In the case of the supervised learning, the training data labeled with a correct answer is used for each training data (i.e., the labeled training data) and in the case of the unsupervised learning, the correct answer may not be labeled in each training data. That is, for example, the training data in the case of the supervised learning related to the data classification may be data in which category is labeled in each training data. The labeled training data is input to the neural network, and the error may be calculated by comparing the output (category) of the neural network with the label of the training data. As another example, in the case of the unsupervised learning related to the data classification, the training data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a training cycle (epoch). The learning rate may be applied differently according to the number of repetition times of the training cycle of the neural network. For example, in an initial stage of the training of the neural network, the neural network ensures a certain level of performance quickly by using a high learning rate, thereby increasing efficiency and uses a low learning rate in a latter stage of the training, thereby increasing accuracy.

In training of the neural network, the training data may be generally a subset of actual data (i.e., data to be processed using the trained neural network), and as a result, there may be a training cycle in which errors for the training data decrease, but the errors for the actual data increase. Overfitting is a phenomenon in which the errors for the actual data increase due to excessive training of the training data. For example, a phenomenon in which the neural network that trains a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the training data, regularization, dropout of omitting a part of the node of the network in the process of training, utilization of a batch normalization layer, etc., may be applied.

Disclosed is a computer readable medium storing the data structure according to an exemplary embodiment of the present disclosure.

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an effectively designed data structure, a computing device can perform operations while using the resources of the computing device to a minimum. Specifically, the computing device can increase the efficiency of operation, read, insert, delete, compare, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for training the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for training the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called nodes. The nodes may also be called neurons. The neural network is configured to include one or more nodes.

The data structure may include data input into the neural network. The data structure including the data input into the neural network may be stored in the computer readable medium. The data input to the neural network may include training data input in a neural network training process and/or input data input to a neural network in which training is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight is variable by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network training process and/or a weight in which neural network training is completed. The weight which varies in the neural network training process may include a weight at a time when a training cycle starts and/or a weight that varies during the training cycle. The weight in which the neural network training is completed may include a weight in which the training cycle is completed. Accordingly, the data structure including the weight of the neural network may include a data structure including the weight which varies in the neural network training process and/or the weight in which neural network training is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of training cycle iterations, weight initialization (for example, setting a range of weight values to be subjected to weight initialization), and Hidden Unit number (e.g., the number of hidden layers and the number of nodes in the hidden layer). The data structure is just an example and the present disclosure is not limited thereto.

FIG. 4 is a schematic view illustrating a method of performing selection and optimization of a model by using a trained auto-encoder model by a processor according to an exemplary embodiment of the present disclosure.

Referring to FIG. 4, an exemplary embodiment of the method of performing selection and optimization of a model for the trained auto-encoder model is disclosed. A processor 110 of a computing device 100 according to an exemplary embodiment of the present disclosure may generate a reconstruction error value 402 based on noise 400 by using an auto encoder model 401 trained based on a data set. Further, the processor 110 may perform a first operation 410 of changing a size of the trained auto-encoder model 401 (411) or selecting a new model or a second operation 420 of terminating another operation without performing another operation, based on the reconstruction error value 402 for the noise 400.

In this case, with respect to the first operation 410 and the second operation 420, the reconstruction error value 402 for the noise 400 is compared with a threshold (403), and when the reconstruction error value 402 for the noise 400 is smaller than the threshold, the first operation 410 may be performed and in the remaining case, the second operation 420 may be performed. Here, the threshold may be a value closer to a lowerlimit value between an upperlimit value and a lowerlimit value which the reconstruction error value may have. For example, when the reconstruction error value is normalized to a value between 0 and 1, the threshold may be set to a value (e.g., 0.1) closer to 0. Therefore, when the reconstruction error value 402 for the noise is lower than the threshold, it may be interpreted that the trained auto-encoder model 401 is trained to be close to the identity function, and the first operation 410 may be performed in order to deviate such a state.

The first operation 410 may include an operation of performing retraining after reducing the size of the trained auto-encoder model 401.

The operation of reducing the size of the trained auto-encoder model 401 may include an operation of reducing at least one of a size of a layer, a bottle neck size, or a complexity size of the trained auto-encoder model 401. One of reasons for training the trained auto-encoder model 401 to be close to the identity function, which are mentioned above is that since the complexity of the trained auto-encoder model 401 is higher than the complexity of the training data, the complexity may be reduced through size reduction of the trained auto-encoder model 401.

Meanwhile, the trained auto-encoder model 401 may be a plurality of different trained auto-encoder models 401. Meanwhile, the trained auto-encoder model 401 may be trained auto-encoder models having different sizes or complexities. Therefore, in this case, the operation of changing the size of the trained auto-encoder model 401 may be appreciated as performing retraining after replacing the trained auto-encoder model 401 with auto-encoder models having different sizes.

The second operation 420 is an operation performed when the reconstruction error value 402 for the noise 400 is higher than the threshold. When the reconstruction error value 402 for the noise 400 is higher than the threshold, the trained auto-encoder model 401 is not trained to be close to the identity function, the operation is terminated without a size change.

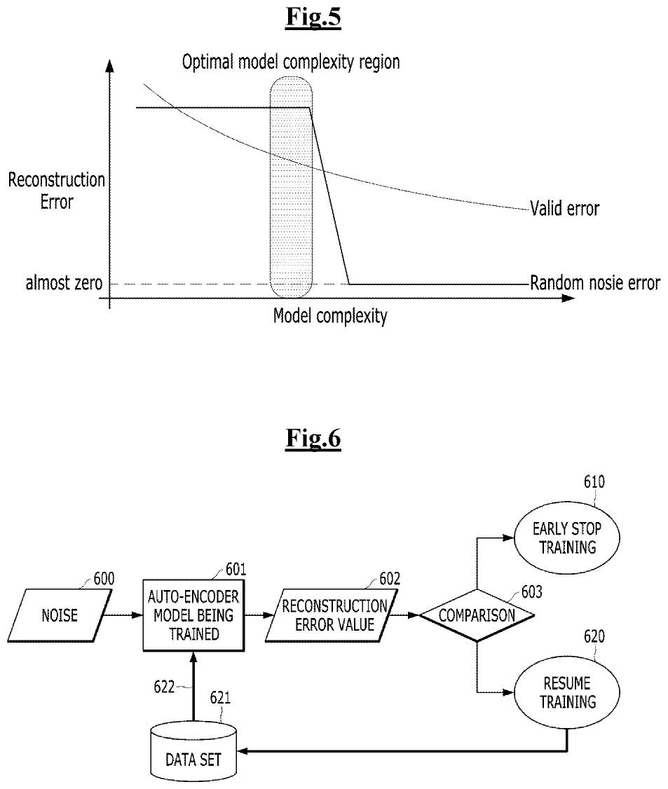

FIG. 5 is a graph for describing a method of calculating an appropriate model size when a processor uses a trained auto-encoder model according to an exemplary embodiment of the present disclosure. The graph expresses a complexity of the model corresponding to a size of the model on a horizontal axis. Further, the reconstruction error value is expressed on a vertical axis. Further, the reconstructed error value (valid error) output based on the data set and a reconstruction error value (random noise error) output based on random noise are expressed. Further, an optimized model size (optimal model complexity region) indicating a size range of a model for optimizing the trained auto-encoder model is expressed. In this case, when the size of the model exceeds the optimized model size, the reconstruction error value output based on the random noise is changed with a comparatively rapid slope and as the size of the model increases, the reconstruction error value is expressed as data close to ‘0’. Further, the reconstruction error value output based on the data set is expressed as non-linear data having value which gently decreases as the size of the model increases.

Referring to FIG. 5, an exemplary embodiment of the method of calculating an appropriate model size when using the trained auto-encoder model performed by the processor 110 of the present disclosure is disclosed. The processor 110 may determine the size of the trained auto-encoder model so that the difference between the reconstruction error value output based on the random noise and the reconstruction error value output based on the data set becomes the maximum, and determine the determined size of the auto-encoder model as an optimized size of the auto-encoder model of which the training is completed. For example, when it is assumed that the trained auto-encoder model is used for the purpose of outputting an abnormal score, a case of inputting the noise and a case of inputting the normal data are compared, and as the reconstruction error value shows a larger difference, the trained auto-encoder model may have a higher performance. That is, a model size when the performance of the trained auto-encoder model is maximized may be appreciated as the optimized model size. Therefore, the process of adjusting the size of the model in order to make the trained auto-encoder model into the optimized model may also be appreciated as one of the optimization methods.

FIG. 6 is a schematic view illustrating a method of performing model optimization by using an auto-encoder model being trained by the processor according to an exemplary embodiment of the present disclosure.

Referring to FIG. 6, an exemplary embodiment of the method of performing optimization of a model by using the auto-encoder model being trained is disclosed. The processor 110 of the computing device 100 according to an exemplary embodiment of the present disclosure may generate a reconstruction error value 602 based on noise 600 by using an auto encoder model 601 being trained based on a data set. Further, the processor 110 may perform a third operation 610 of early stopping training of the auto-encoder model 601 being trained based on the reconstruction error value 602 for the noise 600 or a fourth operation 620 of resuming a training 622 based on a data set 621.

In this case, with respect to the third operation 610 and the fourth operation 620, the reconstruction error value 602 for the noise 600 is compared with a threshold (603), and when the reconstruction error value 602 for the noise 600 is smaller than the threshold, the third operation 610 may be performed and in the remaining case, the fourth operation 620 may be performed. Here, the threshold may be a value closer to a lowerlimit value between an upperlimit value and a lowerlimit value which the reconstruction error value may have. For example, when the reconstruction error value is normalized to a value between 0 and 1, the threshold may be set to a value (e.g., 0.1) closer to 0. Therefore, when the reconstruction error value 602 for the noise is lower than the threshold, it may be interpreted that the auto-encoder model 601 being trained is already trained to be close to the identity function, and the third operation 610 may be performed in order to deviate such a state. Further, the third operation 610 may include an operation of stopping the training of the auto-encoder model 601 being trained, and performing the training at a small number of times again. That is, the third operation may repeat a process of inputting the noise 600 into the auto-encoder model being trained again based on the reduced training epoch.

The fourth operation 620 is an operation performed when the reconstruction error value 602 for the noise 600 is higher than the threshold. When the reconstruction error value 602 for the noise 600 is higher than the threshold, the trained auto-encoder model 601 is not trained to be close to the identity function, the training is continuously conducted so as to increase the training epoch.

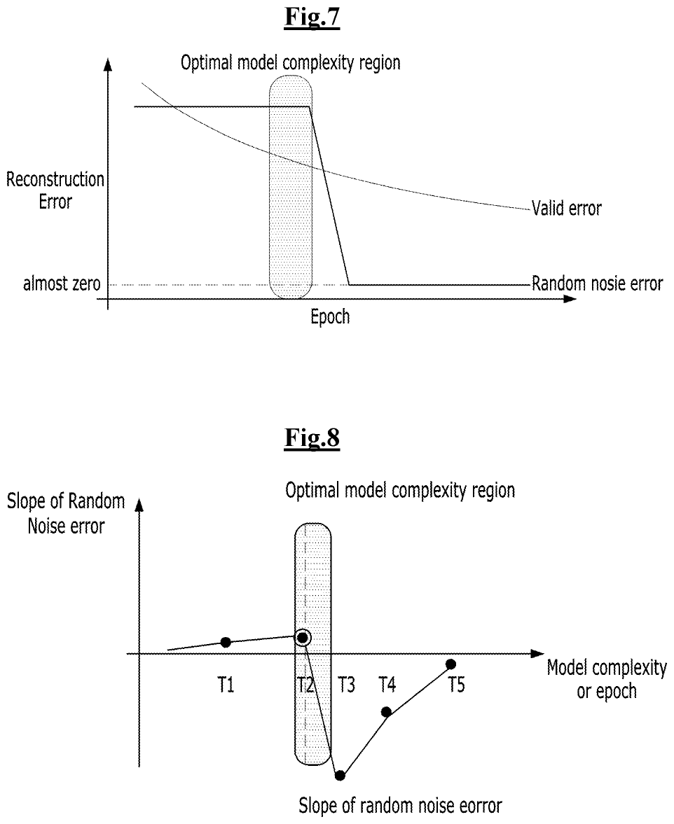

FIG. 7 is a graph for describing a method of calculating an optimal model training epoch by using an auto-encoder model being trained by the processor according to an exemplary embodiment of the present disclosure. The graph expresses the training epoch of the model on a horizontal axis. Further, the reconstruction error value is expressed on a vertical axis. Further, the reconstruction error value output based on the data set and the reconstruction error value output based on the random noise are expressed. In this case, when the optional training epoch exceeds the training epoch of the model, the reconstruction error value output based on the random noise is changed with a comparatively rapid slope and as the training epoch of the model increases, the reconstruction error value is expressed as data close to ‘0’. Further, the reconstruction error value output based on the data set is expressed as non-linear data having a value which gently decreases as the training epoch of the model increases.

Referring to FIG. 7, an exemplary embodiment of the method of calculating the appropriate training epoch when using the auto-encoder model being trained is disclosed. The processor 110 may determine the training epoch of the auto-encoder model being trained so that the difference between the reconstruction error value output based on the noise and the reconstruction error value output based on the data set becomes the maximum, and determine the determined training epoch of the encoder model as an optimized training epoch of the auto-encoder model of which the training is completed. For example, when it is assumed that the auto-encoder model being trained is used for the purpose of outputting an abnormal score, a case of inputting the noise and a case of inputting the normal data are compared, and as the reconstruction error value shows a larger difference, the trained auto-encoder model may have a higher performance. That is, the model earning epoch when the performance of the trained auto-encoder model is maximized may be appreciated as the optimized training epoch. Therefore, the process of early stopping the training of the model during the training of the model in order to make the trained auto-encoder model into the optimized model at the optimized training epoch may also be appreciated as one of the optimization methods.

FIG. 8 is a graph for describing a method of calculating an optimal model training epoch or the model size by using an auto-encoder model processor of which training is completed or an auto-encoder model being trained by the processor according to an exemplary embodiment of the present disclosure. The graph expresses a size (complexity) of the model or the training epoch of the model on a horizontal axis. Further, a slope of a random noise error output based on the noise is expressed on a vertical axis. Further, points T1 to T5 indicate a size value (or training epoch) of an exemplary model in which a model performance is checked. In this case, a slope (hereinafter, referred to as “a slope of the noise loss value”) of the reconstruction error value output based on the noise corresponding to point T2 may be, for example, a value indicating a changed degree by comparing the noise loss value at point T2 and the noise loss value at point T1. Further, a range of the size (or training epoch) of the model for optimizing the trained auto-encoder model is expressed. In this case, ii may be identified that the slopes of points T1 to T5 becomes the maximum around T2 which is a point which reaches the size (or training epoch) of the optimized model, and becomes the minimum at point T3 which is a next point of T2. Therefore, by analyzing that point where the slope of the noise loss value becomes the maximum or the point where the slope of the noise loss value becomes the minimum, points where the size (or training epoch) of the auto-encoder model is optimal may be inferred.

Referring to FIG. 8, an exemplary embodiment of the method of calculating the optimal model size when using the trained auto-encoder model is disclosed. The processor 110 may analyze the slope of the noise loss value, and identify the size of the auto encoder model which allows the slope to become the maximum or the minimum. In this case, in order to determine the optimal size of the auto-encoder model, the identified size information (size information which allows the slope of the noise loss value to be the maximum or the minimum) of the auto-encoder model may be utilized.

For example, the processor may identify point T2 where the slope becomes the maximum, and then determine the optimal model size around T2. Further, the processor may identify point T3 where the slope becomes the minimum, and then determine the optimal model size around a previous point (e.g., a previous point away from point T3 by a predetermined difference) of point T3.

Additionally, when a plurality of trained auto-encoders in which the model size is 1 to 10 are referred to as a first model to a tenth model, a model size in which the slope of the noise loss value becomes the maximum is 4 and a model size in which the slope of the noise loss value according to the model size becomes the minimum is 5, the processor may select a fourth model having a model size of 4 as the optimal model or calculate a new optimal model between the fourth model and the fifth model.

Referring to FIG. 8, an exemplary embodiment of the method of calculating the optimal training epoch when using the auto-encoder model being trained, which is performed by the processor 110 of the present disclosure is disclosed. The processor 110 may analyze the slope of the noise loss value for the training epoch change of the auto-encoder model being trained, and identify the training epoch which allows the slope to be the maximum or the minimum. In this case, in order to determine the optimal training epoch of the auto-encoder model, the identified training epoch (training epoch which allows the slope of the noise loss value to be the maximum or the minimum) may be utilized.

For example, the processor may identify point T2 where the slope becomes the maximum, and then determine the optimal training epoch around T2. Further, the processor may identify point T3 where the slope becomes the minimum, and then determine the optimal training epoch around a previous point (e.g., a previous point away from point T3 by a predetermined difference) of point T3.

Additionally, for example, in relation to the auto-encoder model being trained, when the training epoch in which the slope of the noise loss value depending on the training epoch becomes the maximum is 4 and the training epoch which becomes the maximum is 5, 4 may be determined as the optimal training epoch. Meanwhile, when the training epoch in which the slope of the noise loss value depending on the training epoch becomes the maximum is 4 and the training epoch which becomes the maximum is 6, 4 or 5 may be determined as the optimal training epoch through an additional analysis.

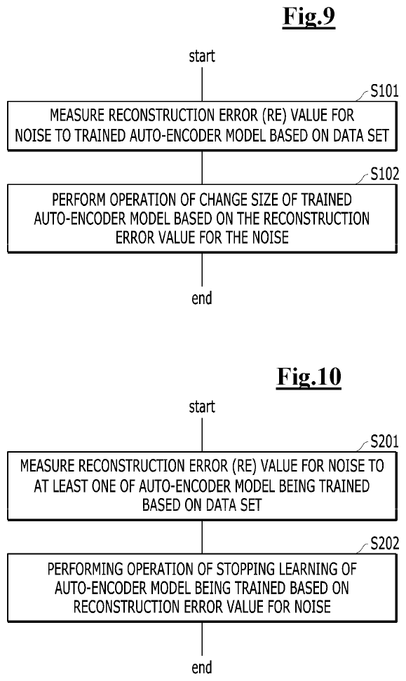

FIG. 9 is a flowchart illustrating a method of performing selection and optimization of a model by using a trained auto-encoder model by a processor according to an exemplary embodiment of the present disclosure.

Referring to FIG. 9, an exemplary embodiment of the method of performing selection and optimization of a model by using the trained auto-encoder model is disclosed. The processor 110 may measure the reconstruction error value for the noise with respect to the trained auto-encoder model based on the data set in step S101. Further, the processor 110 may perform an operation of changing the size of the trained auto-encoder model based on the reconstruction error value for the noise in subsequent step S102.

In this case, step S102 may include a step of comparing the reconstruction error value for the noise and a threshold, and a step of performing an operation of reducing the size of the trained auto-encoder model when the reconstruction error value for the noise is smaller than the threshold.

The operation of changing the size of the trained auto-encoder model may include an operation of changing at least one of the layer size, the bottleneck size, or the complexity size of the trained auto-encoder model.

Step S102 may further include a step of determining the size of the encoder model which allows the difference between the reconstruction error value for the noise and the reconstruction error value for the data set becomes the maximum, and a step of determining the determined size of the auto-encoder model as the optimized size of the auto-encoder model of which the training is completed.

In step S102, the reconstruction error value for the noise may correspond to a noise loss value indicating a difference between input random noise and reconstructed noise.

Meanwhile, the method may further include a step of analyzing the slope of the change of the noise loss value for the change of the size of the trained auto-encoder model, a step of identifying the size of the auto-encoder model which allows the slope to be the maximum or the minimum, and a step of utilizing the size information of the identified auto-encoder model in order to determine the optimal size of the auto-encoder model.

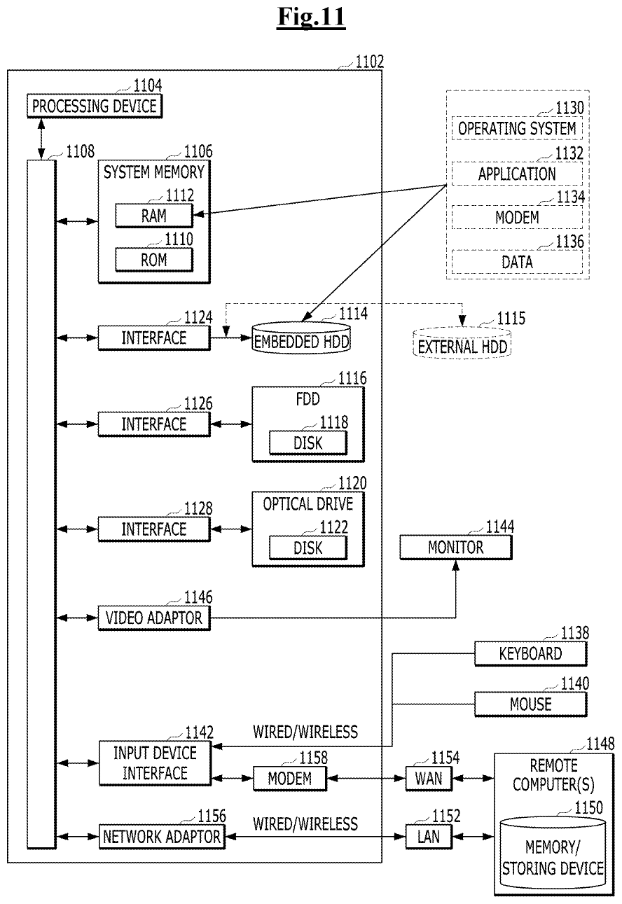

FIG. 10 is a flowchart illustrating a method of performing model optimization by using an auto-encoder model being trained by the processor according to an exemplary embodiment of the present disclosure.

Referring to FIG. 10, an exemplary embodiment of the method of performing selection and optimization of a model by using the auto-encoder model being trained is disclosed. The processor 110 may measure the reconstruction error value for the noise with respect to the trained auto-encoder model based on the data set in step S201. Further, the processor 110 may perform an operation of stopping the training of the auto-encoder model being trained based on the reconstruction error value for the noise in subsequent step S202.

In this case, step S202 may include a step of comparing the reconstruction error value for the noise and a threshold, and a step of stopping the training of the auto-encoder model being trained when the reconstruction error value for the noise is smaller than the threshold.

Step S202 may further include a step of determining a training epoch which allows the difference between the reconstruction error value for the noise and the reconstruction error value for the data set becomes the maximum, and a step of stopping the training of the auto-encoder model after conducting the determined training epoch.

The reconstruction error value for the noise may correspond to a noise loss value indicating a difference between input random noise and reconstructed noise.

The method may also include analyzing the slope of the change of the noise loss value for the change of the training epoch, identifying the training epoch which allows the slope to be the maximum or the minimum, and utilizing the identified training epoch information in order to determine the optimal training epoch.

FIG. 11 is a normal and schematic view of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method for performing an operation related to an auto-encoder model, the method performed by a computing device including at least one processor, the method comprising:
measuring a reconstruction error (RE) value for noise with respect to at least one of a trained auto-encoder model or an auto-encoder model being trained based on a data set;
deriving a difference between the reconstruction error value for the noise and a reconstruction error value for the data set;
performing at least one operation of an operation of changing a size of the trained auto-encoder model or an operation of determining a training epoch of the auto-encoder model being trained, in a direction that maximizes the difference;
analyzing a slope of a change of the reconstruction error value for the noise with respect to at least one of a change of the size of the trained auto-encoder model or a change of the training epoch of the auto-encoder model being trained;
identifying at least one of size information or training epoch information of the auto-encoder model that causes the slope to become a maximum or a minimum; and
utilizing at least one of the size information or the training epoch information of the auto-encoder model in order to determine at least one of an optimal size or an optimal training epoch of the auto-encoder model.

2. The method of claim 1, wherein the performing includes
comparing the reconstruction error value for the noise and a threshold, and
performing at least one operation of an operation of reducing the size of the trained auto-encoder model or an operation of stopping training of the auto-encoder model being trained when the reconstruction error value for the noise is smaller than the threshold.

3. The method of claim 1, wherein the operation of changing the size of the trained auto-encoder model includes an operation of changing at least one of a layer size, a bottle neck size, or a complexity size of the trained auto-encoder model.

4. The method of claim 1, further comprising:
determining the size of the encoder model so that the difference between the reconstruction error value for the noise and the reconstruction error value for the data set becomes a maximum; and
determining the determined size of the encoder model as an optimized size of the auto-encoder model of which the training is completed.

5. The method of claim 1, wherein the reconstruction error value for the noise corresponds to a noise loss value indicating a difference between input random noise and reconstructed noise.

6. The method of claim 1, further comprising:
determining the training epoch such that the difference between the reconstruction error value for the noise and the reconstruction error value for the data set becomes a maximum; and
stopping the training of the auto-encoder model after conducting the determined training epoch.

7. A computer program stored in a non-transitory computer-readable storage medium, wherein when the computer program is executed by one or more processors, the computer program include codes which allow the one or more processors to perform an operation related to an auto-encoder model, and the codes comprising:
a code for measuring a reconstruction error (RE) value for noise with respect to at least one of a trained auto-encoder model or an auto-encoder model being trained based on a data set;
a code for deriving a difference between the reconstruction error value for the noise and a reconstruction error value for the data set;
a code for performing at least one operation of an operation of changing a size of the trained auto-encoder model or an operation of determining a training epoch of the auto-encoder model being trained, in a direction that maximizes the difference;
a code for analyzing a slope of a change of the reconstruction error value for the noise with respect to at least one of a change of the size of the trained auto-encoder model or a change of the training epoch of the auto-encoder model being trained;
a code for identifying at least one of size information or training epoch information of the auto-encoder model that causes the slope to become a maximum or a minimum; and
a code for utilizing at least one of the size information or the training epoch information of the auto-encoder model in order to determine at least one of an optimal size or an optimal training epoch of the auto-encoder model.

8. A device comprising:
a processor including one or more cores; and
a memory,
wherein the processor is configured to
measure a reconstruction error (RE) value for noise with respect to at least one of a trained auto-encoder model or an auto-encoder model being trained based on a data set,
derive a difference between the reconstruction error value for the noise and a reconstruction error value for the data set,
perform at least one operation of an operation of changing a size of the trained auto-encoder model or an operation of determining a training epoch of the auto-encoder model being trained, in a direction that maximizes the difference,
analyze a slope of a change of the reconstruction error value for the noise with respect to at least one of a change of the size of the trained auto-encoder model or a change of the training epoch of the auto-encoder model being trained,
identify at least one of size information or training epoch information of the auto-encoder model that causes the slope to become a maximum or a minimum and
utilize at least one of the size information or the training epoch information of the auto-encoder model in order to determine at least one of an optimal size or an optimal training epoch of the auto-encoder model.
